(19) United States
(12) Patent Application Publication
(10) Pub. No.: US 2011/0196658 A1
(43) Pub. Date: Aug. 11, 2011

(54) METHOD FOR TESTING THE BEHAVIOR OF A PROCESS INSTALLATION

(75) Inventors: Martin Lohmann, Gerlinger (DE); Monika Heisterkamp, Ditzingen (DE)

(73) Assignee: Endress + Hauser Conducta Gesellschaft fur Mess- und Regeltechnik mbH + Co. KG, Gerlingen (DE)

(21) Appl. No.: 13/122,777

(22) PCT Filed: Sep. 18, 2009
(86) PCT No.: PCT/EP09/62086

§ 371 Date: Apr. 6, 2011

(30) Foreign Application Priority Data
Oct. 9, 2008 (DE) 10 2008 050 612.5

(51) Int. Cl. G06G 7/48

(52) U.S. Cl. 703/6

(57) ABSTRACT

A method for testing the behavior of a process plant as a function of the signals of a sensor, wherein the process plant includes at least one measuring chain with a measurement transmitter, which converts the sensor signal and outputs a measured value, and which has at least one sensor interface for connection of the sensor, wherein the method includes steps as follows: connecting a sensor simulator to the sensor interface for forming a test arrangement; selecting, by means of an input function on the measurement transmitter, a sensor signal to be simulated or a sequence of sensor signals to be simulated; transmitting from the measurement transmitter to the sensor simulator a selection signal corresponding to the selected sensor signal to be simulated or the selected sequence of sensor signals to be simulated; and transmitting from the sensor simulator to the measurement transmitter a simulated sensor signal assigned to the selection signal or a sequence of simulated sensor signals assigned to the selection signal.

The invention relates to a method for testing the behavior of a process plant as a function of the signals of a sensor, wherein the process plant includes at least one measuring chain with a measurement transmitter, which converts the sensor signal and outputs a measured value, and which has at least one sensor interface for connection of the sensor.

The terminology, measuring chain, in connection with the present invention means the transmission path of a primary sensor signal (which depends on a parameter to be measured) to a measurement transmitter, which receives the sensor signal or a conditioned sensor signal, in order to process such further, especially in order to ascertain a measured value from such. The measurement transmitter has a sensor interface, via which it is connected with the sensor during measurement operation. Furthermore, the measurement transmitter can be connected with a superordinated unit, for example, a control station of the process plant. The process plant can comprise a plurality of measuring chains for different measuring tasks and for a plurality of measured variables.

Measurement transmitters are installed on-site and configured in accordance with the measurement task and connected to the process control station. For checking, whether all adjustments were correctly performed, frequently, instead of the sensor, a sensor simulator is connected via the sensor interface with the measurement transmitter and the desired measuring range and, in given cases, error states stepped through. Thus, it can be checked, whether the configuration of the measurement transmitter was done correctly, and whether, especially, error states are correctly recognized and corresponding alarm reports correctly generated. Furthermore, it can, in this way, be checked, whether the corresponding signals are correctly forwarded to the control station.

Known from DE 103 22 278 A1 is a simulator for testing a measurement transmitter with a measurement transmitter interface, wherein the sensor simulator has a simulator interface, which is connectable to the measurement transmitter interface and outputs signals to the measurement transmitter and/or receives signals from the transmitter. The sensor simulator includes, in such case, furthermore, a control circuit for the simulation of signals, which form the output signal on the simulator interface. The simulator can furthermore have a signal input, which can be connected to a communication output of the measurement transmitter, in order to enable feedback of the transmitter signals. The simulated signals can simulate measured values, status data or calibration data. The simulator can have a memory module, which has the functionality of a sensor memory module, wherein the control circuit is suitable for generating signals for initializing read- and/or write commands on the part of the measurement transmitter.

Described in DE 10 2005 041427 A1 is a sensor simulator for testing the behavior of a process plant as a function of the signals of a sensor, whose signals are simulated by the sensor simulator. The process plant includes, in such case, at least one measuring chain with a sensor interface for the connection of the sensor, to which the sensor simulator is connectable, wherein the simulator has a measuring chain interface, which is connectable to the sensor interface of the measuring chain, and outputs signals to the measuring chain and/or receives signals from the measuring chain, and a control circuit for the simulation of signals, which form the output signal on the measuring chain interface. The signals can also comprise time curves of measurement signals. The simulator can comprise different test routines with different time curves, wherein the test routines are selectable or sequentially performable by an operator.

The simulators of these or similar embodiments known from the state of the art require, besides a self-sufficient simulation circuit and/or a control circuit, most often, input elements and a display, by means of which a service person triggers, for example, by input of a desired measured value, the output of a simulated sensor signal corresponding to the measured value. In this way, by means of one and the same simulator, a plurality different process plants, or different measuring chains with different measuring tasks within a process plant can be tested. On the other hand, such an embodiment is relatively complex and therewith expensive, especially since such simulators are produced only in small piece numbers and, in given cases, also a calibrating of the control circuits is required for the simulation of measurement signals. A further disadvantage in the application of such simulators for the testing of process plants is that input elements on the sensor simulator are susceptible to damage in the case of difficult environmental conditions, for example, in the case of outdoor plants in poor weather or cold weather.

Known from DE 103 44 262 A1 is a plug-in module for measurement signal simulation. The plug-in module is pluggable to a sensor module head, which is a component of a sensor interface of a measurement transmitter. The plug-in module includes a microcontroller, which operates a switch connected with a digital-analog converter. With help of the digital-analog converter, a predetermined voltage can be produced, which simulates a measurement voltage for a signal processing unit within the plug-in module. Via the sensor module head, the so simulated, measured value is transmitted and, in given cases, forwarded to a superordinated unit. The plug-in module is embodied as key-ring pendant and can thus be easily carried by a service person. Such a plug-in module as sensor simulator is, indeed, relatively simply constructed, however, here only the sensor signal stored, in each case, in the microcontroller can be simulated. There is no opportunity for the service person, directly at the location of use of the plug-in module, to change the simulated measured value or to select between different types of signals.

Although such plug-in modules are relatively simply constructed, their application in a method for testing the behavior of a process plant has, compared with the application of simulators, which make use of input functions, by means of which a service person can, directly at the location of use of the plug-in module, establish the measured value to be simulated, the disadvantage, that a test can be performed only for certain measuring chains with a limited number of measuring tasks. For testing all measuring paths of the process plant, it is necessary, consequently, as a rule, to provide a number of such plug-in modules, which, in each case, simulate different types of sensor signals, e.g. signals of a pH-sensor and of a gas sensor, or, in each case, different sensor signals of the same type, e.g. sensor signals corresponding to different pH-values.

It is, consequently, an object of the invention to provide a method for testing the behavior of a process plant as a function of the signals of a sensor, which method overcomes the disadvantages of the state of the art. Especially, the method should be applicable to a plurality of process plants, or to a plurality of measuring chains within a process plant, while, however, simultaneously utilizing a sensor simulator that is constructed as simply as possible.

This object is achieved by a method for testing the behavior of a process plant as a function of the signals of a sensor, wherein the process plant includes at least one measuring chain with a measurement transmitter, which converts the sensor signal and outputs a measured value, and which has at least one sensor interface for connection of the sensor, wherein the method comprises steps as follows: Connecting a sensor simulator to the sensor interface for forming a test arrangement; selecting, by means of an input function on the measurement transmitter, a sensor signal to be simulated or a sequence of sensor signals to be simulated; transmitting from the measurement transmitter to the sensor simulator a selection signal corresponding to the selected sensor signal to be simulated or the selected sequence of sensor signals to be simulated; and transmitting from the sensor simulator to the measurement transmitter a simulated sensor signal assigned to the selection signal or a sequence of simulated sensor signals assigned to the selection signal.

In this method, the sensor signal to be simulated is thus not set by an input on the sensor simulator or by a program routine stored in the sensor simulator. Instead, the measurement transmitter, which in any event has input elements (for example, keys or a rotate-press switch) and a display, is utilized also for the input of sensor signals to be simulated. In this way, the sensor simulator itself can be embodied very simply; especially, input elements on the sensor simulator itself can be omitted. The sensor simulator is, thus, robust and simultaneously price favorable as regards manufacture; it can, however, in spite of this, be applied for the testing of a plurality of measuring chains for many different measuring tasks in different process plants.

Transmission of the selection signal occurs via the sensor interface of the measurement transmitter and is received by the sensor simulator via its measuring chain interface. Correspondingly, transmission of the simulated sensor signal or the sequence of simulated sensor signals occurs from the sensor simulator via its measuring chain interface back to the measurement transmitter via the sensor interface of the measurement transmitter. Since, in each case, the same interface is used for transmission of the selection signal and transmission of the simulated sensor signal or the sequence of simulated sensor signals, construction of the sensor simulator is simplified still further compared with sensor simulators known from the state of the art.

In an embodiment, the sensor simulator includes a measuring chain interface, wherein the measuring chain interface is connected to the sensor interface of the measurement transmitter, wherein the measuring chain interface comprises an inductive interface for, especially, bidirectional data exchange and/or energy exchange with a complementary inductive sensor interface of the measurement transmitter. Data exchange from the measurement transmitter to the sensor, or to the sensor simulator, occurs, for example, by transmitter-side modulation of the energy signal and data transmission from the sensor to the measurement transmitter, or from the sensor simulator to the measurement transmitter, occurs, for example, by sensor-side, or sensor simulator-side, load modulation of the energy signal.

In an additional embodiment, the sensor simulator includes a microprocessor, a data memory and a program memory, wherein the simulated sensor signal or the sequence of sensor signals is calculated from the selection signal by means of a program stored in the program memory, or read-out from the data memory based on the selection signal, for example, from a table stored in the data memory.

In an additional embodiment, energy supply of the sensor simulator occurs via the sensor interface of the measurement transmitter. This has the advantage that the sensor simulator need not possess its own energy supply, and, thus, can be constructed especially simply.

In an additional embodiment, both the selection signal as well as also the simulated sensor signal or the sequence of simulated sensor signals are digital signals. In this way, a control circuit for producing a simulated sensor signal and especially a changing of the sensor signal to be simulated first into an analog signal and then back into a digital signal, which can be transmitted via the interface to the measurement transmitter, as described in DE 103 44 262 A1, can be omitted.

In an additional embodiment, the sensor simulator has a display, in which the selection signal transmitted to the sensor simulator from the measurement transmitter is displayed. This can be used for simple function checking, especially for reviewing, that the selection signals corresponding to the signals to be simulated selected on the measurement transmitter are correctly transmitted to the sensor simulator. For this, a simple 7-segment display can be used, in which, for example, the measured value corresponding to the sensor signal to be simulated is displayed. In the case, in which a pH-sensor signal is simulated, this would be, for example, a pH-value.

In an additional embodiment, selection of the sensor signal to be simulated occurs on the measurement transmitter via a selection menu, especially by means of a rotate-press switch on the measurement transmitter.

In an additional embodiment, both the selected sensor signal to be simulated as well as also the simulated sensor signal received from the sensor simulator, or a measured value derived from the simulated sensor signal, are displayed on a display of the measurement transmitter. This enables a service person, simultaneously, to select a sensor signal to be simulated and to check the corresponding measured value ascertained by the measurement transmitter from the simulated sensor signal and displayed.

In an embodiment, the simulated sensor signal can correspond to the output signal of a pH-sensor, a conductivity sensor or a gas sensor, especially an oxygen sensor.

The described method can be performed especially by means of a test arrangement for testing the behavior of a process plant as a function of the signals of a sensor, whose signals are simulatable by a sensor simulator, wherein the process plant includes at least one measuring chain with a measurement transmitter, which has a sensor interface for connection of the sensor, wherein the sensor simulator has a measuring chain interface, which is connectable to the sensor interface of the measurement transmitter for forming the test arrangement, and which is designed to output signals to the measuring chain and to receive signals from the measurement transmitter, wherein the measurement transmitter is designed to output via its sensor interface a selection signal to the sensor simulator and the sensor simulator is designed, based on the selection signal received via its measuring chain interface, to output a simulated sensor signal via its measuring chain interface to the sensor interface of the measurement transmitter, and therewith to the measurement transmitter.

In contrast to the test arrangements described in DE 103 22 278 A1 and DE 10 2005 041427 A1, in the case of which the sensor simulator likewise has a signal input connectable with a communication output of the measurement transmitter, or the measuring chain, here, only a single sensor interface on the measurement transmitter and a single measuring chain interface (i.e. no additional signal input) on the sensor simulator are required for the selection and output of a simulated sensor signal. Of course, this does not exclude that the sensor simulator or the measurement transmitter has other interfaces for data exchange with other devices or for use in other applications.

The invention will now be explained in greater detail based on the example of an embodiment illustrated in the drawing, the sole FIGURE of which shows as follows:

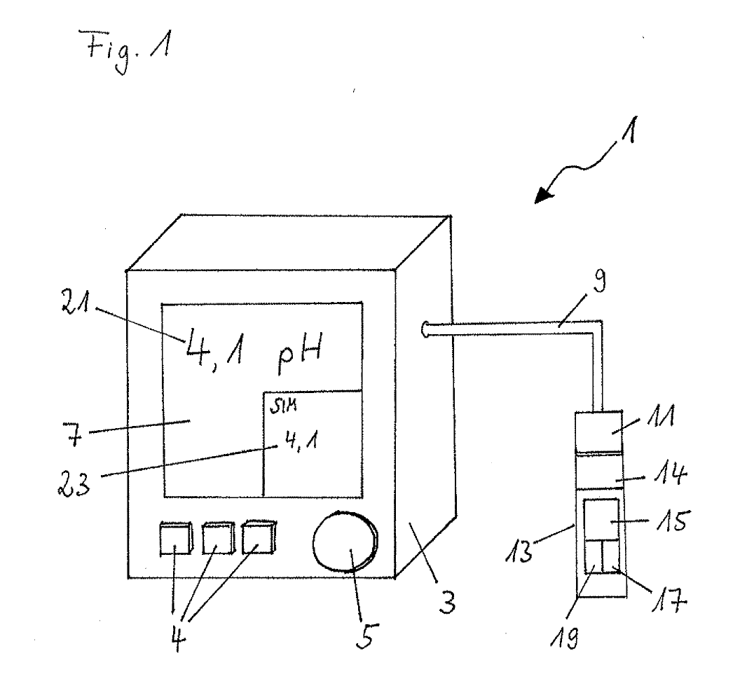

FIG. 1 a schematic representation of a test arrangement for performing a method for testing the behavior of a process plant by means of a sensor simulator.

FIG. 1 shows a test arrangement 1, by means of which a measuring chain of a process plant can be tested. In the following, the corresponding test method is explained based on a measuring chain for pH measurement. However, the invention is not limited to measuring chains for pH measurement. As explained above, the method can be applied equally to measuring chains for other measured variables and measuring tasks, for example, for measuring conductivity, gas sensing, or temperature measurement, to the extent that a measurement transmitter with a corresponding sensor interface is present.

The measurement transmitter 3 has a housing with press switches 4 and a rotate-press switch 5 (a so-called jog-switch) as input elements, as well as a display 7. With the switches 4 and 5, a service person can select different menus on the display 7. The measurement transmitter 3 can, furthermore, be connected with a superordinated unit (not shown), for example, a process control station.

The measurement transmitter 3 is connected via a sensor cable 9 with a first element 11 of a pluggable connector coupling. The first element 11 forms a sensor interface of the measurement transmitter 3, to which during measurement operation a sensor is connected. In test operation, there is connected to the first element 11 of the pluggable connector coupling a sensor simulator 13. Sensor simulator 13 is connected to the first element 11 via a measuring chain interface in the form of a second element 14 of the pluggable connector coupling. Second element 14 is complementary to the first element 11.

In the example of an embodiment presented in FIG. 1, the pluggable connector coupling between measurement transmitter 3 and sensor simulator 13, or sensor (not shown), is embodied as a galvanically isolated, inductively coupling, plugged connection. Such a pluggable connector coupling is described, for example, in EP 1206012 A2. In principle, other interfaces can also be used, to the extent that data and preferably also energy can be transmitted in both directions via the interface.

Sensor simulator 13 includes a microcontroller 15, a program memory 17 and a data memory 19. A method for testing the process plant, of which the measuring chain composed of sensor, sensor interface, measurement transmitter 3 and process control system forms a part, will now be described as follows:

On the measurement transmitter 3, a simulation mode can be invoked, for example, by actuating one of the keys 4. On the display 7 in this mode, two fields appear, wherein in a first field the measured value 21 determined by the measurement transmitter 3 from the signal delivered via the sensor interface 11 is presented. In the present case, such is a pH value. In a second field of the display 7, simultaneously, a simulation menu is presented, in which a service person, for example, by actuating the rotate-press switch 5, can select a sensor signal to be simulated. Advantageously, the simulation mode can be so designed that, in the simulation menu, not the actual sensor signal (for example, in the case of a pH sensor, a voltage) is selectable, but, instead, the associated measured value 23 to be simulated—in the present example, the pH value.

If a measured value 23 to be simulated has been selected, for example, by pressing the rotate-press switch, an associated selection signal is transmitted via the sensor cable 9 and the sensor interface 11, 14 to the sensor simulator 13 and written into the data memory 19. The selection signal corresponding to the measured value to be simulated can be stored, for example, in a memory of the measurement transmitter 3. By means of a program stored in the program memory 17, the microprocessor 15 of the sensor simulator 13 can calculate from the selection signal the sensor signal to be simulated. Alternatively, for each possible, selectable selection signal, there can also be stored in a table in the data memory 19 the corresponding sensor signals to be simulated. The sensor signal to be simulated assigned to the selection signal is then transmitted by the sensor simulator via the measuring chain interface 11, 13 back to the measurement transmitter 3. The measurement transmitter 3 determines from the simulated sensor signal, quite analogously as from the output signal of the sensor during measurement operation, a measured value and shows this as measured value 21 in the first field of the display 7. The measurement transmitter 3 can derive other information from the simulated sensor signal and this, in given cases, is transmitted together with the measured value and/or the simulated sensor signal onwards to the process control station. For reviewing correct functioning of the transmission of the selection signal, the sensor simulator can be equipped with a display (not shown), in which the selection signal transmitted by the measurement transmitter 3 to the sensor simulator 13, or a value corresponding to this selection signal, for example, a pH value, which corresponds to the selected pH value 23, is displayed in the simulation menu.

Besides the testing of whether the simulated signal is correctly transmitted to the measurement transmitter 3 and further processed thereby, it can furthermore be checked, whether signals derived by the measurement transmitter 3 from the measurement signal, or from the measured value, as, for example, the output of an alarm in the case of exceeding a pH limit value, as well as the forwarding of an alarm signal or other signals to the process control station, correctly function. For this purpose, for example, the pH value 23 selectable in the simulation menu can be varied in such a manner that a predetermined pH limit value is exceeded, and it is then checked, whether output of the desired alarm occurs.

In a further development, there can be stored in a memory of the measurement transmitter 3 or in the process control station, for example, implemented in a plant asset management tool (PAM-tool, i.e. a software for monitoring a process plant), test routines, which provide, for example, simulation of different time curves of the signal to be simulated. These routines can be selected, for example, with the assistance of the rotate-press switch 5 in the simulation mode of the measurement transmitter 3 via a menu shown in the display 7. The measurement transmitter 3 then sends to the sensor simulator 13, according to the selected routine, a single selection signal, or a sequence of selection signals, on the basis of which the microcontroller 15, using a program module stored in the program memory 17, generates, and sends to the measurement transmitter 3, a corresponding sequence of simulated sensor signals having the time curve provided according to the selected test routine.

If the routine is implemented in the process control station in a software for monitoring the process plant, there is the opportunity for generating a test protocol, in which, besides the simulated sensor signals transmitted by the sensor simulator 13 to the measurement transmitter 3 and forwarded to the process control station, also additional data ascertained from the simulated sensor signals, such as e.g. measured values, derived alarm signals, etc. are captured.

Furthermore, it is advantageous to provide in the data memory 19 of the sensor simulator 13 a predetermined, fixed sensor signal, that is transmitted to the measurement transmitter 3 upon connecting of the sensor simulator to the sensor interface 11 of the measurement transmitter 3 and upon starting of the test arrangement, so long as the sensor simulator 13 receives no selection signal from the measurement transmitter 3. In this way, it is assured that the measurement transmitter 3 always receives a defined signal in the case of connected sensor simulator 13.

The sensor simulator can also have a number of measuring chain interfaces, which, in each case, is assigned to its own data memory. Each data memory contains a predetermined sensor signal to be simulated, wherein the sensor signals contained in each data memory can be, for example, different sensor signals assigned to the same measured variable, e.g. the pH value of a medium, or also sensor signals for different types of sensors, for example, a pH sensor, a conductivity sensor and an oxygen sensor. In the latter case, the sensor simulator can be connected to a sensor interface of the measurement transmitter with that measuring chain interface, which is assigned to that data memory of the sensor simulator, which contains a predetermined simulated sensor signal, which corresponds to a sensor signal of the sensor connected during measurement operation to the same sensor interface.

The invention is not limited to the illustrated examples of embodiments and includes every other technically possible type of implementation falling within the scope of the following claims. Especially, transmission of signals between measurement transmitter and sensor, or sensor simulator, and transmission of the signals between measurement transmitter and process control system in both directions, can also occur wirelessly, for example, by infrared radiation, radio waves, GSM, ZigBee, Bluetooth, UMTS, and/or WLAN.

1-10. (canceled)

11. A method for testing behavior of a process plant as a function of signals of a sensor, wherein the process plant includes at least one measuring chain with a measurement transmitter, which converts the sensor signal and outputs a measured value, and which has at least one sensor interface for connection of the sensor, wherein the method comprises the steps as follows:
connecting a sensor simulator to the sensor interface for forming a test arrangement;
selecting, by means of an input function on the measurement transmitter, a sensor signal to be simulated or a sequence of sensor signals to be simulated;
transmitting from the measurement transmitter to the sensor simulator a selection signal corresponding to the sensor signal to be simulated or the sequence of sensor signals to be simulated; and
transmitting from the sensor simulator to the measurement transmitter a simulated sensor signal assigned to the selection signal or a sequence of simulated sensor signals assigned to the selection signal.

12. The method as claimed in claim 11, wherein:
the sensor simulator has a measuring chain interface and the measuring chain interface is connected to the sensor interface of the measurement transmitter;
the measuring chain interface comprises an inductive interface for data exchange and/or energy exchange with a complementary inductive sensor interface of the measurement transmitter.

13. The method as claimed in claim 12, wherein:
the sensor simulator comprises a microprocessor, a data memory and a program memory;
the simulated sensor signal or the sequence of simulated sensor signals is calculated from the selection signal by means of a program stored in the program memory or read-out from the data memory based on the selection signal.

14. The method as claimed in claim 11, wherein:
the sensor simulator is supplied with energy via the sensor interface of the measurement transmitter.

15. The method as claimed in claim 11, wherein:
both the selection signal as well as also the simulated sensor signal or the sequence of simulated sensor signals are digital signals.

16. The method as claimed in claim 11, wherein:
the sensor simulator has a display, in which the selection signal transmitted to the sensor simulator by the measurement transmitter or a value corresponding to this selection signal is displayed.

17. The method as claimed in claim 11, wherein:
selection of the sensor signal to be simulated occurs via a selection menu on the measurement transmitter, especially by input by means of a rotate-press switch.

18. The method as claimed in claim 11, wherein:
both the selected sensor signal to be simulated as well as also the simulated sensor signal received from the sensor simulator or a measured value derived from the simulated sensor signal are displayed on a display of the measurement transmitter.

19. The method as claimed in claim 11, wherein:
the simulated sensor signal corresponds to a signal of a pH sensor, a conductivity sensor or a gas sensor, especially an oxygen sensor.

20. A test arrangement for testing behavior of a process plant as a function of signals of a sensor, whose signals are simulatable by a sensor simulator, wherein the process plant includes at least one measuring chain with a measurement transmitter, which has a sensor interface for connection of the sensor, said sensor simulator has a measuring chain interface, which is connectable to the sensor interface of the measurement transmitter for forming the test arrangement,
the sensor simulator is designed to output signals to the measuring chain and to receive signals from the measurement transmitter,
the measurement transmitter is designed to output via its sensor interface a selection signal to the sensor simulator and the sensor simulator is designed to output via its measuring chain interface, based on the selection signal received via its measuring chain interface, a simulated sensor signal to the sensor interface of the measurement transmitter.
